(19) United States
(12) Patent Application Publication
(10) Pub. No.: US 2014/0122264 A1
(43) Pub. Date: May 1, 2014

(54) SYSTEMS AND METHODS FOR INTEGRATING ACCOUNTING SOFTWARE AND PAYMENT PROCESSING SYSTEMS

(71) Applicant: Norse Corporation, Clayton, MO (US)

(72) Inventors: Brent Gebhart, Roswell, GA (US); Samuel M. Glines, St. Louis, MO (US); Sheldon H. Foss, JR., Wildwood, MO (US)

(21) Appl. No.: 13/803,868

(22) Filed: Mar. 14, 2013

Related U.S. Application Data
(60) Provisional application No. 61/718,595, filed on Oct. 25, 2012.

(51) Int. Cl. G06Q 40/00

(52) U.S. Cl. CPC G06Q 40/10
USPC 705/16

(57) ABSTRACT

Systems and methods for automating the real-time recording of accounting transactions in accounting software using remote computing devices implementing support for payment card readers and processing vendors not supported by the accounting software.

### CROSS REFERENCE TO RELATED APPLICATION(S)

This application claims the benefit of U.S. Provisional Patent Application 61/718,595, filed Oct. 25, 2012, the entire disclosure of which is herein incorporated by reference.

### BACKGROUND

1. Field of the Invention

This disclosure is related to the field of retail transactions, specifically, the integration of computerized accounting systems with point-of-sale transactions.

2. Description of the Related Art

The use of computer technology in retail sales is well-established. Businesses large and small account for expenses and revenues using accounting principles, and because of the amount of math involved and the repetitiveness of the calculations performed, accounting principles are particularly well-suited to computer-based solutions. A variety of software products are now available to provide computerized accounting systems to businesses.

Some of these products are comprehensive enterprise-grade systems, but the majority of small businesses use lightweight systems designed specifically for small business. By a large margin, the most popular product is Intuit® QuickBooks®, believed to command a 70-95% market share, but other products do exist, including: Xero; Sage; PeachTree; GnuCash; in Dinero; and FrontAccounting. Small business accounting software improves accuracy, reduces manual processes, reduces arithmetical errors, and provides a number of other useful features for small businesses. However, switching from paper-based accounting to computerized accounting has drawbacks.

The core design of these products ultimately and necessarily is an implementation of accounting principles in software, but there are retail contexts in which accounting principles are clumsy and unwieldy. With paper-and-pencil accounting, ad hoc work-arounds are often trivial, but the rigidity and inflexibility of computer software, which does only and exactly what it is programmed to do, can make computerized accounting systems awkward and inconvenient for certain types of transactions. However, because the accounting functions of the software are still valuable and useful, small business owners are forced to waste time and effort working around the software in contexts where the implementation does not match how the company does business.

For example, accounting relies upon invoicing to identify the quantities and prices of goods or services ordered. When an order is placed, an invoice is created in the accounting software containing this information, and optionally other information, such as the particular job or customer for whom the invoice was created, and the method or terms of payment. The invoice amount is then debited in the software as a line item to an “account receivable,” reflecting a debt owed to the business by a customer or client. Accounts receivable are important because, under accounting rules, they are an asset of the business which appears on other accounting documents, such as a balance sheet reflecting the business's overall financial condition.

When the job is completed, or the goods or services are delivered or performed, payment is collected and credited back to the account receivable for the amount paid. If the payment amount matches the invoice, the invoice is “closed,” and the resulting net change in the account receivable for the transaction is $0. However, the payment amount may differ for a number of reasons, leaving a net debit in the account receivable. For example, the customer may have paid the wrong amount in error or may be returning goods, or the customer may be dissatisfied and the parties negotiate an alternate rate. In those circumstances, additional accounting may be necessary to prevent the account receivable balance from carrying a net debit for that transaction, thus inappropriately reflecting an asset that the business does not actually possess. For example, if the client owing the debt goes out of business, the invoice amount may be credited to accounts receivable to remove the debt as a business asset, but then debited to an uncollectable debt account which is later written off or sold to a collection agency.

These fundamental units of work all revolve around the invoice, which is the source of the debit and credit amounts, and which links up a particular line item in the accounting records to specific products or services, customers, and/or jobs being done. However, in many point-of-sale retail transactions, invoices are a hassle. For example, at a fast food restaurant, the order is taken, prepared, and filled, and payment is accepted over a span of only a few minutes. The cashier does not fill out an invoice, debit the total against accounts receivable, accept payment, close the invoice, and credit the payment back to accounts receivable. Other techniques may be used, such as abstracting all of the transactions for a particular drawer for a particular period of time as a single line item of cash revenue in the accounting system, without reconciling individual receipts. However, this methodology loses information granularity and compromises the business's ability to connect a particular transaction with a particular set of entries in the accounting system.

Instead, the business may save copies of sales receipts for the day and, at the close of the business day, go through the receipts one by one, create an invoice for each, record the payment transaction, and close each invoice. This process is time-consuming, error-prone, and exhausting, particularly in high volume point-of-sale retail businesses. But, since the engine of computerized accounting systems runs on invoices, the owner must create and close those invoices at the end of the business day to track business at the transaction level, manually linking up customers, jobs, and amounts to maintain the integrity of the accounting system and preserve information granularity.

Some computerized accounting systems also support payment card processing, whereby the business owner can accept payments with a debit card, credit card, or gift card using the accounting software, but these systems introduce additional problems. For one, many computerized accounting systems integrate payment processing only with specific institutions or vendors. However, small businesses tend to use the bank which holds their small business loans as their payment processor, often because the business receives that service as a part of a package, or simply to strengthen the business relationship with the lending institution. Further, accounting software is a national market, and accounting software firms tend to partner with national vendors and institutions. However, small businesses often rely on local institutions more familiar with the small business and its owners. This means small businesses must either use a payment processor integrated into the software, which may not offer favorable rates or terms, or the small business must conduct payment card transactions and generate paper receipts and invoices, and then manually enter and reconcile these transactions at the end of the day, losing much of the benefit of an integrated payment system.

Similarly, a convenient way to accept a payment card is through a device which reads information from the payment card's magnetic strip. These “card swipers” are now ubiquitous in businesses, ranging from separate devices plugged into traditional cash registers, to devices integrated into the cash register, to miniaturized devices plugged into a mobile phone, such as the Square™ Card Reader. For an integrated payment processing module in accounting software, however, the business may only use devices supported by the software. As with the payment processing vendor, the accounting software company may have partnered only with specific device manufacturers. Further, in the case of newer technologies like the Square™ Card Reader, there simply may be no way for the device to interface with the computer running the accounting software. As with the payment processing vendor, the small business has little choice but to either use a supported card reader, or conduct the transactions separately and manually reconcile the paperwork in the accounting system after hours, again sacrificing much of the benefit of using card readers.

Finally, using an integrated card reader or processing vendor in a point-of-sale retail transaction requires that the computer having the accounting system be at the point of sale. For a traditional brick-and-mortar retail store, this is generally undesirable. For one, accounting data would then be stored on a computer system located within the store rather than at a secure facility, and is at heightened risk for damage, theft, or other loss. Second, in modern point-of-sale transactions, it may be difficult or impossible to use a computer. For example, a photographer taking family pictures at a remote lake simply cannot drag a desktop computer system along; even a laptop may be too inconvenient to carry along with photography equipment. If the accounting software doesn't support a mobile device, such as a tablet computer or mobile phone application, the photographer must manually keep records of the transactions, and enter and reconcile them manually, yet again re-introducing inconvenience and opportunity for error.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, are systems and methods for integrating point-of-sale retail transaction systems with small business accounting software systems. The systems and methods described herein allow point-of-sale systems to conduct payment card transactions using any payment processing vendor and/or any card reading mechanism, and to automatically enter those transactions with small business accounting software, whether or not the small business accounting software supports those specific payment processing vendors and/or card reading mechanisms. The systems and methods described herein also allow the end-user of small business accounting software to interface with the software on any computing platform, whether or not the small business accounting software is supported on that platform. The systems and methods described herein also allow the end-user to automatically create, reconcile, and close invoices in the small business accounting software in connection with point-of-sale transactions. The systems and methods described herein also automatically identify customers, jobs, and/or invoices based on information associated with a given payment transaction.

Also described herein, among other things, are systems and methods for automating the real-time recording of accounting transactions in accounting software using remote computing devices implementing support for payment card readers and processing vendors not supported by the accounting software.

Also described herein, among other things, is a method for automatically recording an accounting transaction in real-time comprising: providing an accounting software computer connected to a data network and including: a memory having computer-readable instructions comprising accounting software; an accounting database in a format usable by the accounting software; providing a remote computer device communicating with the accounting software computer over the data network; supplying the remote computer device with transaction data related to a point of sale transaction as part of the point of sale transaction; in response to receiving the transaction data and without human direction the remote computer device sending to the accounting software computer over the data network a data structure including a recording instruction and at least some of the transaction data; in response to the accounting software computer receiving the data structure and without human direction the accounting software recording in the accounting database an accounting transaction instructed by the recording instruction, the accounting transaction including at least some of the transaction data from the data structure; automatically recording an accounting transaction in real-time.

In another embodiment of the method, at least some of the transaction data in the data structure includes a payment amount and the recording instruction instructs the accounting software to create in the accounting database an invoice for the point of sale transaction, the invoice having an invoice amount equal to the payment amount.

In another embodiment of the method, the recording instruction further instructs the accounting software to close the invoice.

In another embodiment of the method, the data structure including at least some of the transaction data includes a payment amount and the recording instruction instructs the accounting software to close an existing open invoice for the point of sale transaction.

In another embodiment of the method, the accounting software identifies the existing open invoice at least in part by matching the payment amount with the amount of the existing open invoice.

In another embodiment of the method, the remote computer device is a mobile device.

In another embodiment of the method, the mobile device is a mobile phone or tablet computer.

In another embodiment of the method, the method further comprises: in the providing a remote computer device, the remote computer device further comprising a display; and in the supplying step, the supplying including a human inputting the transaction data into a user interface displayed on the display.

In another embodiment of the method, the user interface is a web page.

In another embodiment of the method, the data structure is a qbXML object.

Also described herein, among other things, is a method for automatically recording in accounting software a transaction using an unsupported device comprising: providing an accounting software computer connected to a data network and having: an accounting database; a memory having computer-readable instructions comprising accounting software supporting automatic recording in the accounting database of an accounting transaction corresponding to a payment made using a supported payment card reader; providing a remote computer device communicating with the accounting software computer over the data network and having connected thereto a payment card reader communicating with the remote computer device, the payment card reader being unsupported by the accounting software; accepting a payment for a point of sale transaction with the unsupported payment card reader; the unsupported payment card reader supplying the remote computer device with transaction data related to the point of sale transaction as part of the point of sale transaction; in response to receiving the transaction data and without human direction the remote computer device sending to the accounting software computer over the data network a data structure including a recording instruction and at least some of the transaction data; in response to the accounting software computer receiving the data structure and without human direction the accounting software recording in the accounting database an accounting transaction instructed by the recording instruction, the accounting transaction including at least some of the transaction data from the data structure; automatically recording in the accounting software the point of sale transaction using the unsupported payment card reader.

In another embodiment of the method, the method further comprises: acquiring a cardholder identifier from a payment card read by the unsupported payment card reader; in the supplying step, the unsupported payment card reader supplying the remote computer device with the cardholder identifier; in the sending step, the data structure including the cardholder identifier; in the recording step, the accounting transaction including the cardholder identifier.

In another embodiment of the method, the cardholder identifier is a primary account number.

In another embodiment of the method, the cardholder identifier is a name.

In another embodiment of the method, the method further comprises: the remote computer device sending to a payment card processing vendor the cardholder identifier supplied to the remote computer device; the remote computer device receiving from the payment card processing vendor a response including cardholder personal data related to the cardholder identifier; in the sending step, the data structure including at least some of the cardholder personal data received by the remote computer device; in the recording step, the accounting transaction including at least some of the cardholder personal data from the data structure.

Also described herein, among other things, is a method for recording in accounting software a transaction processed by an unsupported payment processing vendor comprising: providing an accounting software computer connected to a data network and having: an accounting database; a memory having computer-readable instructions comprising accounting software supporting automatic recording in the accounting database of an accounting transaction corresponding to a payment processed by a supported payment card processing vendor; providing a remote computer device communicating with the accounting software computer over the data network and processing a payment made by a payment card using a payment card processing vendor unsupported by the accounting software; accepting a payment for a point of sale transaction with a payment card; reading from the payment card a cardholder identifier; sending to the unsupported payment card processing vendor a payment processing request including the cardholder identifier; receiving from the unsupported payment card processing vendor an indication of a disposition of the payment processing request; the remote computer device sending to the accounting software computer over the data network a data structure including transaction data relating to the point of sale transaction and a recording instruction corresponding at least in part to the indication of a disposition; the accounting software computer receiving the data structure and the accounting software recording in the accounting database an accounting transaction instructed by the recording instruction, the accounting transaction including at least some of the transaction data from the data structure.

In another embodiment of the method, the cardholder identifier is a primary account number.

In another embodiment of the method, the cardholder identifier is a name.

In another embodiment of the method, the method further comprises: in the receiving step, further receiving from the unsupported payment card processing vendor cardholder personal data related to the cardholder identifier; in the sending step, the data structure including at least some of the cardholder personal data; in the recording step, the accounting transaction including at least some of the cardholder personal data from the data structure.

### BRIEF DESCRIPTION OF THE DRAWINGS

FIG. 1 depicts a schematic drawing of a prior art accounting transaction recording system using a third party payment processing vendor.

FIG. 2 depicts a schematic drawing of an embodiment of systems and methods for recording remote point of sale transactions in accounting software.

FIG. 3 depicts a schematic drawing of another embodiment of systems and methods for recording remote point of sale transactions in accounting software.

FIGS. 4-9 depict embodiments of a web site interface for use in an embodiment of the systems and methods.

FIG. 10 depicts an embodiment of a splash screen for use in an embodiment of the systems and methods.

FIG. 11 depicts an embodiment of a form for generating reports for use in an embodiment of the systems and methods.

FIG. 12 depicts an embodiment of an interface for issuing invoices for use in an embodiment of the systems and methods.

### DESCRIPTION OF PREFERRED EMBODIMENTS

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, and mainframe computers.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer,” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable binary files, object code, compiled libraries, implementations, algorithms, or any instruction or set of instructions capable of being executed by a computer processor, or capable of being converted into a form capable of being executed by a computer processor, including without limitation, virtual processors, or by the use of run-time environments or virtual machines. Those of ordinary skill in the art recognize that software can be wired directly onto hardware, including without limitation onto a microchip, and still be considered “software” within the meaning of this disclosure. For purposes of this disclosure, software includes, without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers.

Throughout this disclosure, the term “real time” refers to software operating within operational deadlines for a given event to commence or complete, or for a given module, software, or system to respond. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second.

The term “accounting software” as used herein should be understood to refer to a suite or system of software designed to record and process accounting transactions. Such systems may be implemented as a standalone application, a suite or set of applications, a web interface, software-as-a-service, a combination of these, or any other mechanism for delivering application programming functionality to an end-user, and may include other modules, functions, or local modifications. This term includes but is not limited to accounting rules and logic, user interface, and data storage components, and may support operations concerning, among other things: accounts payable; accounts receivable; payroll; inventory; taxes; other assets and/or liabilities; loans; billing; sales; purchase ordering; invoicing; general ledger; cash flow; reporting; charts; and graphs; reconciliation; and, billing. By way of example and not limitation, this term includes Intuit® QuickBooks®.

The terms “API” and “SDK” are familiar to those of ordinary skill in the art and should be understood as interchangeable for purposes of this disclosure. By way of example and not limitation, the API/SKD for Intuit® QuickBooks® includes libraries of methods and functions for populating and extracting data and attributes in qbXML, a defined subset of the Extensible Markup Language (“XML”) standard, and exchanging qbXML objects with Intuit® QuickBooks®.

Although the present invention is described with particular reference to the accompanying drawings, it is to be understood at the outset that it is contemplated that the present invention may vary in specific detail from that illustrated and described herein while still achieving the desirable characteristics and features of the present invention. Accordingly, the description that follows is intended to be understood as a broad enabling disclosure directed to persons skilled in the applicable arts, and is not to be understood as being restrictive.

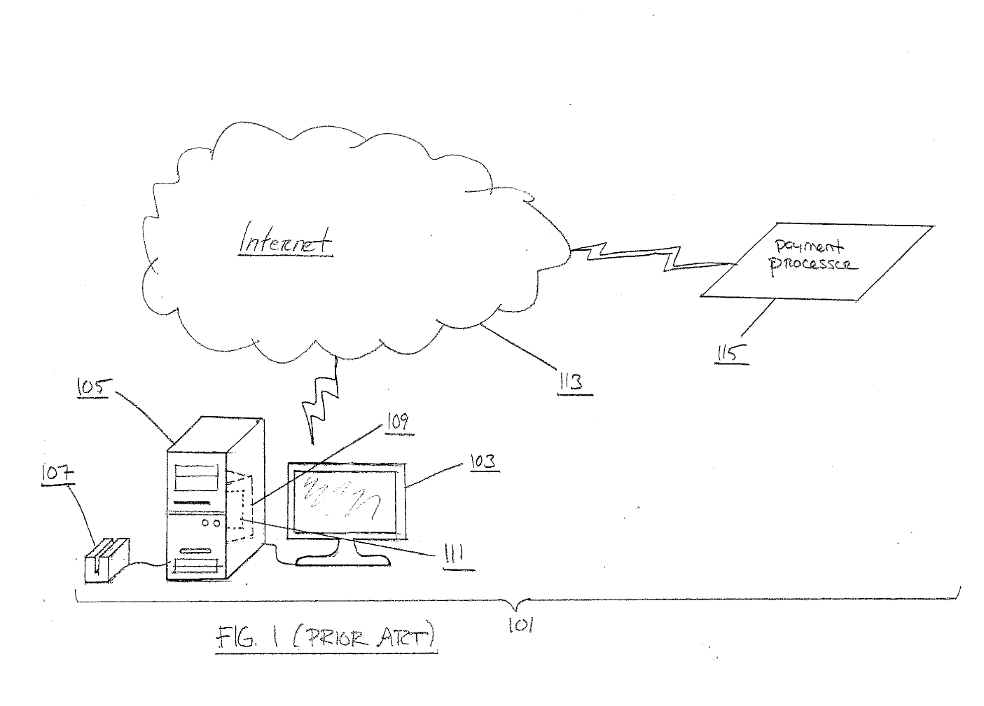

FIG. 1 depicts a prior art computerized accounting system. In the depicted embodiment, an accounting software computer (105) has accounting software (111) installed via storage media (109) and also has an interface (103) and a payment card reader (107), as well as communications means (113) to a payment processing vendor (115). In the depicted prior art, the communications means (113) is an Internet (113) connection, but payment card transactions have used direct-dial and other means. In the depicted prior art, the user must use a payment card reader (107) supported by the installed accounting software (111), and may only process payments using a vendor (115) which has partnered with the accounting software (111) company. If the merchant uses an unsupported payment card reader (107), the transactions will not be recorded by the accounting software (111). If the merchant uses an unsupported payment processing vendor (115), the transactions will not be recorded by the accounting software. Thus, if the merchant is unwilling or unable to use the payment processing vendors (115) and/or payment card readers (107) supported by the accounting software (111), the merchant must manually create invoices, enter transactions, and close the invoices, effectively losing important functionality of the accounting software (111).

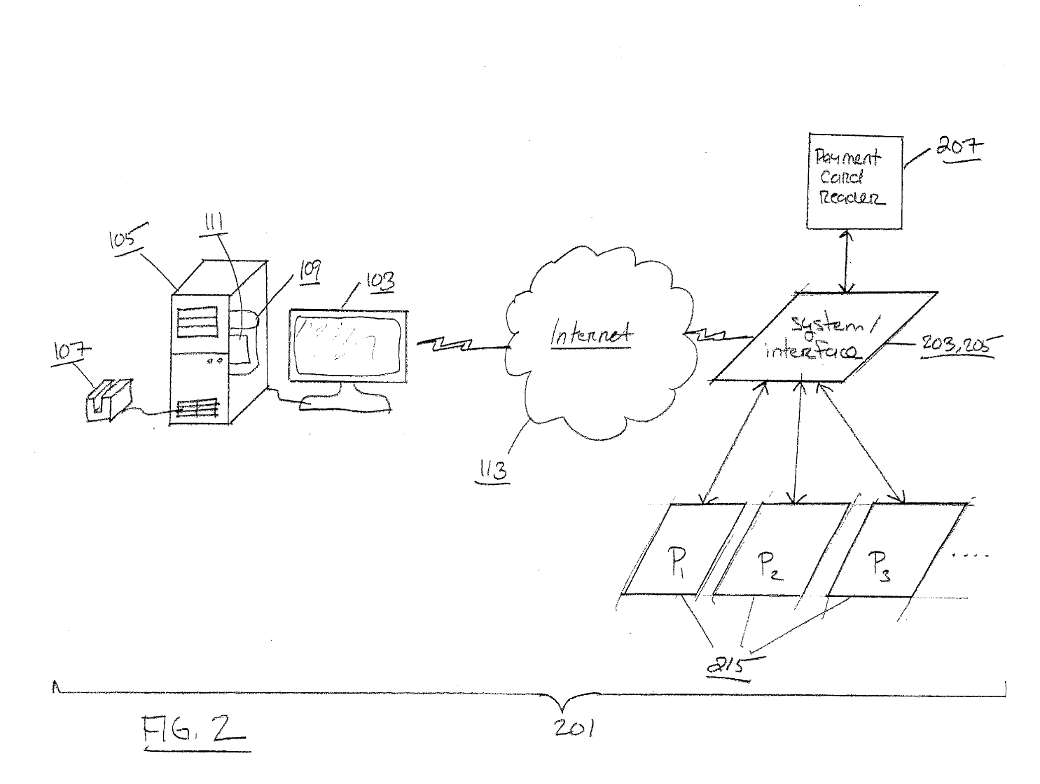

FIG. 2 depicts a conceptual overview of an embodiment of the systems and methods described herein. In the depicted embodiment, the accounting software computer (105) is used to record and process transactions in the accounting software (111), but the integrated payment processing and card reading functionality of the accounting software (111) is not directly used. Rather, a second interface (203) to the accounting software (111) is provided which is independent of the accounting software (111) and independent of the accounting software computer (105). The second interface (203) generally is also a second computer (205) or part of a second computer (205), including but not limited to a standalone application or web-based interface. In the depicted embodiment (201), a merchant interacts with the second interface (203) to, among other things, create, update, and process records pertaining to customers, jobs, transactions, payments, and other accounting and business data and operations. The second interface (203) collects and transmits certain data to the accounting software (111) using the API/SDK to instruct the software to perform certain functions.

By way of example and not limitation, and as discussed in more detail elsewhere in this disclosure, the second interface (203) may allow the merchant to design or create a customized invoice and populate the invoice data fields with appropriate data. This data may be populated by, among other things: manual entry by the merchant or a cashier; automatic entry by the second interface (203), such as defaulting the invoice date to the current date/time; direct entry by the merchant's customer, such as in a self check-out environment; or, automatic population with data gathered from another source, such as from a payment card, personal check, wire transfer, on-line transfer, or rapid payment or pre-paid dongle. This information is then transmitted to the accounting software (111), along with appropriate relationship information and instructions to cause the accounting software (111) to create, update, and interrelate the appropriate records, including but not limited to: customer records, invoice records, payment records, and accounting transactions.

In the depicted embodiment, the second interface (203) and/or computer (205), which shall herein be referred to together as the “remote system” (203) or (205), integrates one or more payment processing vendors (215), and supports one or more payment card readers (207). These payment processing vendors (215) and payment card readers (207) may or may not be supported by the accounting software (111). The depicted embodiment (201) provides a second interface (203) through which the end-user can accept payment card payments using payment card reader (207), and records and processes those transactions in the accounting software (111) using an SDK or API providing access to the accounting software's (111) functions. The systems and methods thus allow the end-user to record and process accounting transactions in the accounting software (111) using payment card readers (207) not supported by the accounting software.

By way of example and not limitation, and as discussed in more detail elsewhere in this disclosure, if a merchant wishes to accept payments using a Square™ Card Reader (207) plugged into an Apple® iPad® (205), but the merchant's accounting software (111) of choice does not integrate or directly support transactions using the Square™ Card Reader, in the prior art the merchant would have to manually track invoices pertaining to those transactions and manually enter the transactions into the accounting software (111).

In the depicted embodiment (201), the second interface (203) supports and integrates the Square™ Card Reader (207), whether or not the accounting software (111) supports or integrates the Square™ Card Reader (207). When a customer wishes to make a payment by payment card, the card is swiped through the Square™ Card Reader (207), and the second interface (203) may interact with the accounting software (111) to locate a matching invoice against which to apply the payment. For example, the second interface (203) may transmit to the accounting software (111) the amount of the payment received at the point-of-sale and instruct the accounting software (111) to return data associated with any unpaid invoices in the accounting software (111) for the exact amount transmitted—i.e., the amount paid. If the accounting software (111) is not capable of processing such a query, the second interface (203) may simply request and/or cache all unpaid invoices stored in the accounting software and the second interface (203) itself may search the invoices for a match.

Regardless of how the search is conducted, if no match is found, the second interface (203) may then transmit to the accounting software (111) appropriate data for creating an invoice in the accounting software (111). For example, the qbXML format used by Intuit® QuickBooks® allows the merchant to create a new invoice associated with a particular invoice template, customer record, and invoice amount. Because the invoice is being created in response to a payment for which there is no prior invoice, the second interface (203) then instructs the accounting software (111) to process payment for that invoice, closing the invoice and making the appropriate accounting entries in the accounting software (111). When the invoice is created by the accounting software (111), the accounting software (111) may return or otherwise make available a unique identifier for that invoice or transaction entry. The second interface (203) then transmits to the accounting software (111) the appropriate payment information, such as the amount of payment, method of payment, customer reference, and a unique identifier of the invoice against which to apply the payment. Because the invoice was created in response to, and for the exact amount of, the payment received, this is an automated and effectively atomic process causing the accounting software (111) to create an invoice and record the appropriate accounting transactions in real-time with the point-of-sale transaction.

It is specifically contemplated that other information may be transmitted and/or stored in addition to what is specifically disclosed in the above example. Such additional information includes, but is not limited to, all information associated with accounting transactions and business operations for the merchant's line of business. For example, the invoice data may include, among other things: date and time order was placed; purchase order number; products or services ordered; unit prices for individual items; payment terms; taxes; product or service descriptions; delivery time, place, or other terms; and contact information for buyer or seller.

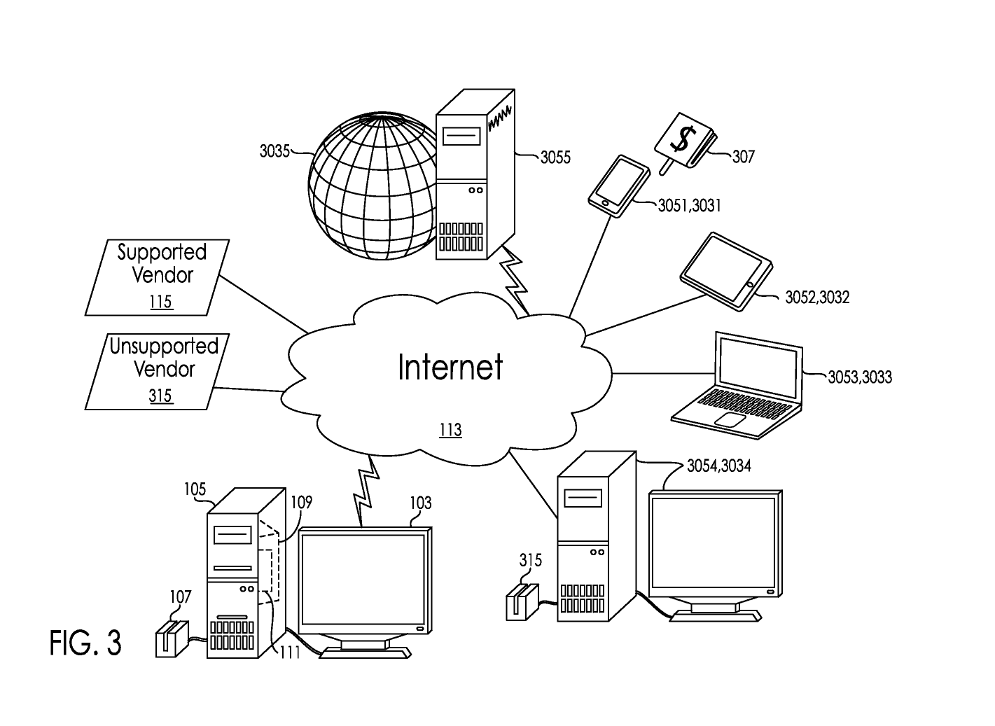

The methods discussed in this disclosure also are applicable to processing payments using a payment processing vendor (215) which is not directly supported by and/or integrated with the accounting software (111). The depicted embodiment (201) provides a second interface (203) through which the end-user can accept and process payment card payments using a payment processing vendor (215) not supported by the accounting software (111), and records and processes those transactions in the accounting software (111) using an SDK or API providing access to the accounting software's (111) functions. Similarly, in the embodiment depicted in FIG. 3, the second interface (3034) supports the merchant's preferred payment processing vendor (315), but the accounting software (111) does not support the merchant's preferred payment processing vendor (315).

It should be noted that the elements may be arranged other than as depicted in FIG. 2. For example, the remote system (203) or (205) may include a single device integrating both computing functionality and an interface, such as an iPhone® having an application or a web browser for viewing a web interface. Also, the remote system (203) or (205) may include a plurality of devices which implement computing functionality and interfaces separately or independently. For example, there may be a second computer (205) which is a web server, and which provides a second interface (203) in the form of a web site. The end-user may interact with the web site (203) through another second computer (205), which is not the web server, such as a tablet computer (205), laptop computer (205), or mobile phone, and that second computer (205) may itself have an interface to the web site (203).

The remote system (203) or (205) can support one or more payment card readers (207), and can support one or more payment processing vendors (215). A payment card reader (207) or payment processing vendor (215) may be the same or different from a payment card reader (107) or payment processing vendor (115) supported by the accounting software (111) and/or coupled or connected with the accounting software computer (105).

In an embodiment, the remote system (203) or (205) may be the same as the accounting software computer (105). For example, the accounting software computer (105) may be a server hosted in a secure facility which also hosts a secure web site (203), and the web site (203) accesses the accounting software (111) locally rather than through the Internet (113).

Because the second computer (205) and second interface (203) are not integrated into the accounting software (111), the design and support features of these elements (205) or (203) are not confined to the set of features implemented by the accounting software (111) vendor. For example, in the embodiment depicted in FIG. 3, the systems and methods support the Square™ Card Reader (307) and the merchant may accept point-of-sale payment card transactions using the Square™ Card Reader (307) via a mobile phone (3031) or tablet computer (3032), and also use the accounting software (111) to record and store those transactions, whether or not the accounting software (111) supports the Square™ Card Reader (307).

The following illustrative example of transactions using the depicted embodiment (201) of FIG. 2 may provide further clarity. A mobile food truck business using Intuit® QuickBooks® (111) for accounting software (111) also uses an embodiment of the systems and methods for point-of-sale transactions during lunch hour in a busy urban area. A customer approaches the food truck places an order for $8.15, and the customer wishes to pay with a credit card. The food truck merchant accepts payment using a Square™ Card Reader (207) plugged into an Apple® iPad® (205). Square™ is both a payment processor (215) and provides card reading hardware (207) in this example. However, Square™ (215) is not integrated with or directly supported by Intuit® QuickBooks® (111) and, even if it were, the merchant does not keep the accounting software computer (105) in the food truck to process transactions throughout the day.

As depicted in FIG. 2, the transaction is facilitated through a second interface (203) on a second computer (205), in this example, a web site (203) accessed on an Apple® iPad® (205). When the Square™ Card Reader (207) reads the magnetic strip on the payment card, the Square™ Card Reader (207) accesses certain information associated with the cardholder, which may include name, card number, expiration date, billing address, residential address, business name, business address, telephone number, email address, and more, depending on what information the credit card and payment vendors collect and transmit for a transaction. This information may then be used to populate a “new customer” form in the second interface (203), which is then reviewed, completed, and approved by a cashier. Once approved, the customer data is transmitted over the communication means (113) to the accounting software (111) on the accounting software computer (105) via the API with instructions to create new customer entry in the accounting software (111). Alternatively, the depicted embodiment (201) may bypass the cashier approval step and automatically transmit customer data associated with the payment card over the communication means (113) to the accounting software (111) on the accounting software computer (105) via the API with instructions to create a new customer entry in the accounting software (111).

Alternatively, the customer may be a returning customer, not a new customer, and the accounting software (111) may already include customer data associated with the returning customer. The depicted embodiment (201) of FIG. 2 may use customer information acquired via the payment card reader (207) to query the accounting software (111) for any matching entries. For example, the customer's name and billing address, or a unique customer identifier, may be sent to the accounting software (111) with instructions to return any matches. If a match is found in the accounting software (111), some or all of the customer data for that customer may be returned to the second interface (203) by the accounting software (111) using the communication means (113). The second interface (203) then may display some or all of the customer data received, and the cashier may compare the stored data to data recently acquired via the payment card reader (207), allowing the cashier to enter and store changes, or identify fraudulent transactions and/or stolen cards, such as by verbally verifying with the customer information previously stored in the accounting system (111). If changes to the customer data are warranted, the cashier can approve those changes, and the updated customer data is then transmitted over the communication means (113) to the accounting software (111) on the accounting software computer (105), to update the customer data in the accounting software (111) associated with the returning customer.

Alternatively, the depicted embodiment (201) of FIG. 2 may bypass the cashier approval step for updated data and proceed to automatically transmit updated customer data associated with the payment card over the communication means (113) to the accounting software (111) on the accounting software computer (105) to update an existing customer entry in the accounting software (111). In another embodiment, customer data may also be stored through means separate from the accounting software (111), and the systems and methods may create or update customer information either in the accounting software (111), in the separate updated customer data storage means, or both.

As discussed elsewhere in this disclosure, invoices may be created and updated in the accounting software (111) in similar fashion. When the order is placed, in this example for $8.15, the depicted embodiment (201) may transmit data to the accounting software (111) to create an invoice for the transaction in that amount. The invoice may be associated with customer and/or product data in the accounting software (111). For example, the depicted embodiment (201) may transmit: identifying customer information, such as name and address or a unique customer identifier; identifying product information, such as SKU, inventory number, or descriptive text; data and time of sale; and/or invoice amount. This information is transmitted to the accounting software (111) over the communication means (113) and the accounting software (111) API is used to instruct the accounting software (111) to create an invoice having the date and time of sale, list of products ordered, and price charges as transmitted.

Data may be collected and transmitted via the second interface (203). Data also may be manually keyed, such as items and quantities ordered, while other data is automatically collected or determined, such as identifying product information for the products ordered, the total invoice amount, date and time of sale, sales taxes, and so forth. In this manner, an invoice is created in the accounting software (111) in real-time with the transaction; the invoice can be created when the customer has completed his order and before payment is accepted. If the customer changes or cancels his order, the identifying product information for the items added or deleted from the order is transmitted to the accounting software (111) with appropriate API instructions to update the invoice in the accounting software (111) accordingly. The accounting software (111) may also be instructed to debit the sale amount to an account receivable to reflect a debt owed to the business. If the order is cancelled, the accounting software (111) may be instructed to cancel and close the invoice and make appropriate accounting entries, again by transmitting appropriate data through the API.

When the customer pays, the depicted embodiment (201) shown in FIG. 2 again transmits appropriate data to the accounting software (111) with instructions to reconcile and close the invoice in the accounting software (111) and make appropriate accounting entries. The second interface (203) instructs the accounting software (111) to accept payment for the invoice associated with the unique invoice identifier, and in the amount entered by the cashier or provided by the payment means, by transmitting to the accounting software (111) through the API appropriate identifying information for the customer and invoice, and instructions for the accounting software (111) to execute the required transactions. Thus, even over the real-time duration of a fast food transaction during a busy lunch hour in a crowded area, the accounting software (111) receives real time instructions and data from the depicted embodiment (201) for creating an invoice for a given customer, and accepting payment on and reconciling that invoice, and making appropriate accounting entries reflecting an order, payment, and fulfillment.

This allows the accounting software (111) to accurately reflect the accounting entries associated with the business operations in real-time, even though the accounting software computer (105) is not located at the point-of-sale. Further, the merchant is able to enjoy the benefits of automating tedious and error-prone processes through computerization, while also using his card reader (207) and payment processing vendor (215) of choice, whether or not those products and/or vendors are directly supported by the accounting software (111).

It should be noted that, under the above exemplary circumstances, customer data associated with a customer is not gathered from the payment card until the card is read by the payment card reader (215). However, an invoice may be created in the accounting software (111) when the order in placed. The invoice cannot be associated with the customer data for the returning customer when the invoice is created, because the customer data for the returning customer has not yet been gathered. The customer can be matched to the invoice, however, when payment is received, because the payment amount and/or date of payment can be used to identify invoices in the accounting software (111) for which a given payment is likely to be associated. Because customer information becomes available once the payment card is read, this information can be used to automatically identify the appropriate invoice, associate the invoice with the appropriate customer, and then reconcile and close the invoice.

The specific or particular means for carrying out these various methods and systems in the second interface (203) depend on the particular functionality required, the nature of the second interface (203) and second computer (205), and the design choices of the architect of the second interface (203). By way of example and not limitation, not all vendors may provide sufficient information associated with the payment card to uniquely identify a customer. For example, only a zip code, and not a full billing address, might be provided. In those circumstances, the second interface (203) may provide to the cashier a list of all customers having that zip code to select from, such as in a drop-down list. The precise format and means for presenting this list is subject to shifting standards of taste and design in user interfaces. In another example, there may be no information provided by the vendor which can narrow the list of potential customers, in which case all customers may be listed in some order, such as by proximity, alphabetically, by most recent transaction, or some other identifying proxy, such as mean payment amount of past transactions.

Certain information pertaining to cardholders is deemed confidential under industry standards, and under best practices standards should not be transmitted through insecure connections, or any more than is necessary, and should not be displayed in its entirety. In an embodiment, confidential cardholder information is not stored on the accounting software computer (105) or a second computer (205), but rather only a token or unique identifier associated with that cardholder data is stored on the accounting software computer (105) or a second computer (205). The cardholder data itself maintained by a standards-compliant third party vendor and is accessed as needed via the token or unique identifier.

When the business owner concludes operations for the day and accesses the accounting software (111), the accounting software (111) has a record of customers and transactions for the day, allowing the business owner to perform customer data analytics, such as identifying new and returning customers, or customers with recent changes in customer data, such as a new address. Because this information is determined, in whole or in part, from data associated with the payment card and these updates are done automatically and in real-time with the actual transactions, the accuracy of the data is the same, or nearly the same, as the accuracy of the payment card data. Thus, the business owner can identify, for example, which customers have relocated, which customers may be new to the area, which customers return the most frequently. Based on such information, the business owner may develop and target marketing incentives, campaigns and strategies for different groups of customers.

In an embodiment, the second computer (205) may be the same computer as the accounting software computer (105), but in the preferred embodiment, the second computer (205) is a different computer from the accounting software computer (105). Similarly, in an embodiment, the second interface (203) is the same interface as the accounting software computer interface (103). In either technique, customer data is created in the accounting software (111) using information acquired in whole or in part from the payment card reader (207) even though the payment card reader (207) is not supported by the accounting software (111), and the update is performed in real-time even though the accounting software computer (105) is not present at the point of sale. Although the second computer (205) may be the same computer as the accounting software computer (105), it is preferred that the second computer (205) is a different computer from the accounting software computer (105). Similarly, the second interface (203) may be the same interface as the accounting software computer interface (103), but it is preferred that the second interface (203) is a different interface from the accounting software computer interface (103).

The accounting software computer (105) may be a server in a secure facility, and the accounting software computer interface (103) may be a computer which accesses the accounting software computer (105) over a communication means (113), such as through a remote desktop protocol. In an embodiment, the second computer (205) may also be used to access the accounting software computer (105) in this fashion, thus making the second computer (205) also function as an accounting software computer interface (103). The precise nature and arrangement of these components may vary from embodiment to embodiment, depending on the specific devices used in a given environment.

The payment card reader (207) may be a separate physical device coupled or connected to another element of the system, such as by a cable or wireless communications channel like Bluetooth®. For example, as depicted in FIG. 3, the payment card reader may be a Square™ Card Reader (307) plugged into an iPhone® (3031). However, in an alternative configuration, the payment card reader (309) may not be a separate physical device. By way of example and not limitation, the payment card reader (307) may be a digital camera integrated into a mobile phone (3031) or tablet computer (3032), which takes a photograph of the payment card. The device (3031) or (3032) may then transmit an image of the card to a vendor or processor to determine the card number and other pertinent information, or the device (3031) or (3032) having the camera may itself provide that functionality. This may be done using, for example, optical character recognition (“OCR”) algorithms. Also by way of example and not limitation, the payment card reader (307) may be an imaging device, such as a web cam, whether coupled or connected to another element of the system or integrated into another element of the system.

Generally, the systems and methods described herein record and process transactions using the accounting software (111) through an SDK or API. These SDKs and APIs provide third party developers with access to the accounting and data management functions of the accounting software (111). The systems and methods may use an SDK or API to automate the invoicing process of the accounting software (111). For example, when a payment is received for a product or service in a point-of-sale transaction, the systems and methods use an SDK/API to create an invoice for the sale amount in the accounting software (111), record a payment of that amount in the accounting software (111), associate the payment with the invoice, and close the invoice. By automating this process, the merchant enjoys the beneficial features of the accounting software (111) without being tied to the specific scanners (107) or payment processors (115) that the accounting software (111) vendor supports, and without manually creating and reconciling invoices.

As discussed elsewhere, the systems and methods may automate the process of matching invoices with payments in transaction contexts where an invoice exists prior to payment, again saving the merchant a manual, time-consuming, and error-prone step. For example, where a customer has ordered goods or services and paid upon delivery, an invoice may already have been created in the accounting software (111). When the merchant accepts payment from the customer, whether or not through a means supported by the accounting software (111), the systems and methods may first use the accounting software (111) SDK/API to determine whether an open invoice for the amount of the payment already exists in the accounting software (111) by querying the accounting software (111) for any open invoices for that customer.

Alternatively, the accounting software may be queried for open invoices having amounts matching the payment amount. If a match is found, the systems and methods may instruct the accounting software (111) to record the payment and reconcile it against the located invoice, to close the invoice, or to perform other or further accounting operations as appropriate to complete the transaction. If there is no such invoice, then the systems and methods may instruct the accounting software (111) to create an invoice for the amount of the payment, record the payment, reconcile the payment against the newly-generated invoice, close the invoice, or to perform other or further accounting operations as appropriate to complete the transaction.

Generally the systems and methods create, update, and retrieve customer information stored or managed by the accounting software (111). Customer information includes common business data such as: contact information; the names and positions of owners, operators, directors, officers, and/or representatives; lines of business; and the like. In an embodiment, the end-user manually enters customer information using the second interface (203), which then uses the accounting software (111) SDK/API to create or update customer information in the accounting software (111) on the accounting software computer (105) by transmitting this data.

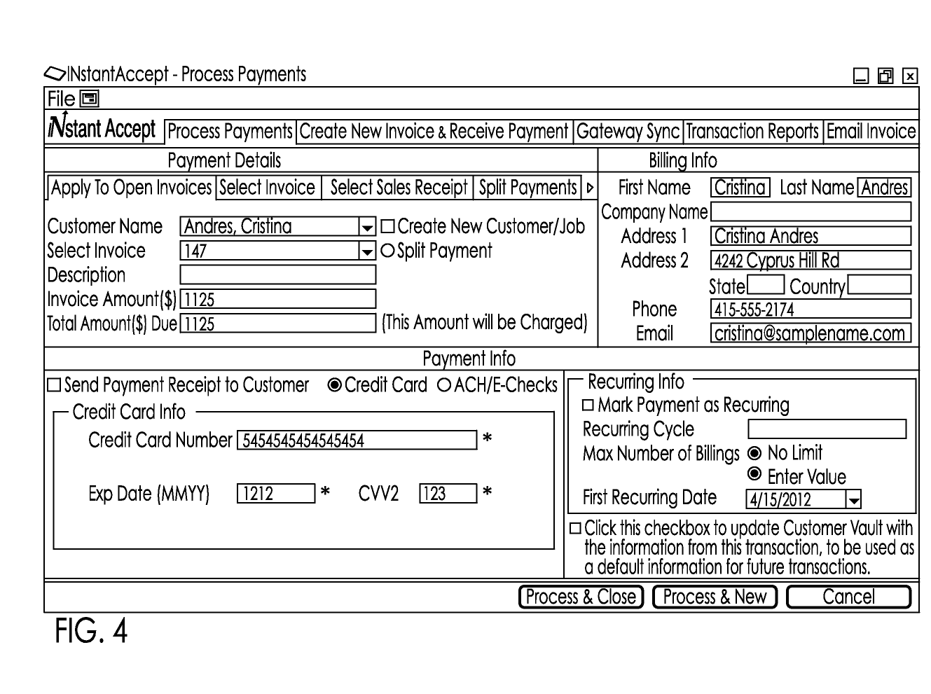

The end-user may also enter customer information automatically. For example, the end-user may retrieve cardholder information from a payment card using a payment card reader (207). The precise arrangement of elements in the second interface (203) for entering this information will generally depend on the design choices and needs for a particular embodiment. For example, in the screenshot depicted in FIG. 4-9, a web site (3035) provides a form having input fields for customer information such as name, company name, address, phone, and e-mail address. Additional, or fewer, fields may be used in an embodiment. The systems and methods may also automatically create new customer information in the accounting software at least in part on information provided by or accessible through the payment mechanism. For example, if the customer pays with a payment card, the payment card reader (107) may receive or extract customer information, which the systems and methods record in the accounting software (111) using the SDK/API. The systems and methods may also identify a returning customer using customer information provided by or accessible through the payment mechanism, and automatically retrieve that customer's records from the accounting software (111) using the SDK/API.

The systems and methods may be used to create, update, and retrieve job information stored or managed by the accounting software (111). Job information includes common business data such as: job number; description; associated customer information; job location; delivery date; foreman; and the like. Generally, the end-user manually enters job information using the second interface (203), which then uses the accounting software (111) SDK/API to create or update job information in the accounting software (111) on the accounting software computer (105). The second interface (203) may use the SDK/API to associate or disassociate customer information with a job, or to associate or disassociate job information with a customer.

The systems and methods generally interact with the accounting software (111) in real-time. For example, when a transaction is completed at the point of sale, the accounting software (111) is updated with invoice and payment records and transactions in real-time such that an end-user using the accounting software (111) would be able to access and review each transaction at about the same time that the transaction is completed at the point of sale. Note that this is an operational context in which “real-time” may necessarily involve delays of more than one second. For example, factors such as network latency, processor load, or task scheduling may cause the accounting software (111) to lag behind the transaction by more than one second of real-time; however, the instructions sent to the accounting software (111) through the SDK/API are issued contemporaneously with the transaction.

It should be noted that any type of record may be updated in real-time with the point-of-sale transaction. For example, if the cashier in a point-of-sale transaction enters new or updated customer or job information, the instructions to create or modify customer or job data are sent to the accounting software (111) through the SDK/API contemporaneously with the transaction.

The systems and methods may support one or more payment processors (315) that are not supported by the accounting software (111). However, the systems and methods may also support one or more payment processors (315) that are supported by the accounting software (111). The systems and methods can also implement cardholder data security standards. For example, cardholder information may not be stored or otherwise transmitted to the accounting software (111), but rather exchanged only with a payment processor (315) and stored, if at all, on a third computer under the custody and control of a payment processor (315) with secure facilities complying with one or more cardholder information security standards. Cardholder information then is displayed to the merchant, if at all, in compliance with appropriate cardholder data security standards, such as by replacing certain of the digits in the card number with Xs. Applicable standards include, but are not limited to, PCI DSS and SAS70.

A merchant may register to use the systems and methods on or through a web site or “app store,” including but not limited to, downloading and installing an application, configuring payment gateways, configuring payment processing vendors, configuring payment card readers, and configuring other options.

A payment gateway would interface with a payment processor (315) as depicted in FIG. 3. While the payment processor (315) is often a bank or other lending or financial institution, the payment processor (315) may be any payment processing platform capable or adaptable for handling financial transactions between a merchant at the point of sale and a financial institution, such as a bank or credit union issuing a credit card. While the payment processor (315) may be affiliated with or part of a banking institution, in another configuration, a payment processor (315) is not affiliated with a financial institution.

A payment processor (315) is generally able to process payment card payments as well as commercial paper, such as personal checks, and may be able to access alternative forms of payment, including but not limited to, payment by coupon, gift card, rewards programs, virtual currency, “e-wallet,” quick pay mechanisms, vouchers, virtual goods, barter exchange, foreign currencies, direct bank transfer, ACH, EFT, customer loyalty currencies, and multichannel payments.

FIG. 3 shows, among other things, combinations of interfaces and devices that may be included in an embodiment. In the embodiment shown in FIG. 3, the second computer (205) may be a mobile phone (3051) and the second interface may be a mobile phone application (3031). The second computer (205) also may be a tablet computer (3052) and the second interface may be a tablet computer application (3032). The second computer (205) also may be a laptop (3053) or desktop (3054) computer, and the second interface may be a software application (3033) executed on the laptop (3053) or desktop (3054) computer. Also by way of example, the second computer may be a web server (3055) and the second interface may be a web site (3035) provided by the web server (3055). Combinations of the foregoing are also specifically contemplated. By way of example and not limitation, the second computer (205) may be a mobile phone (3051), tablet computer (3052), laptop computer (3053), or desktop computer (3054), and the second interface (203) may be a web site (3035) hosted by the web server (3055) and accessed by the mobile phone (3051), tablet computer (3052), laptop computer (3053), or desktop computer (3054) over a communication channel (113).

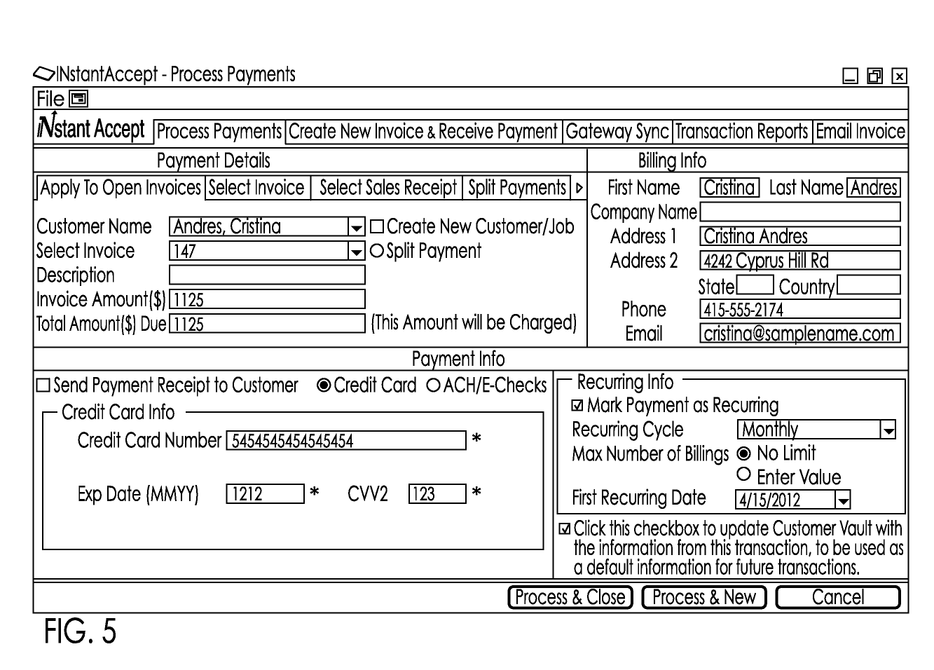

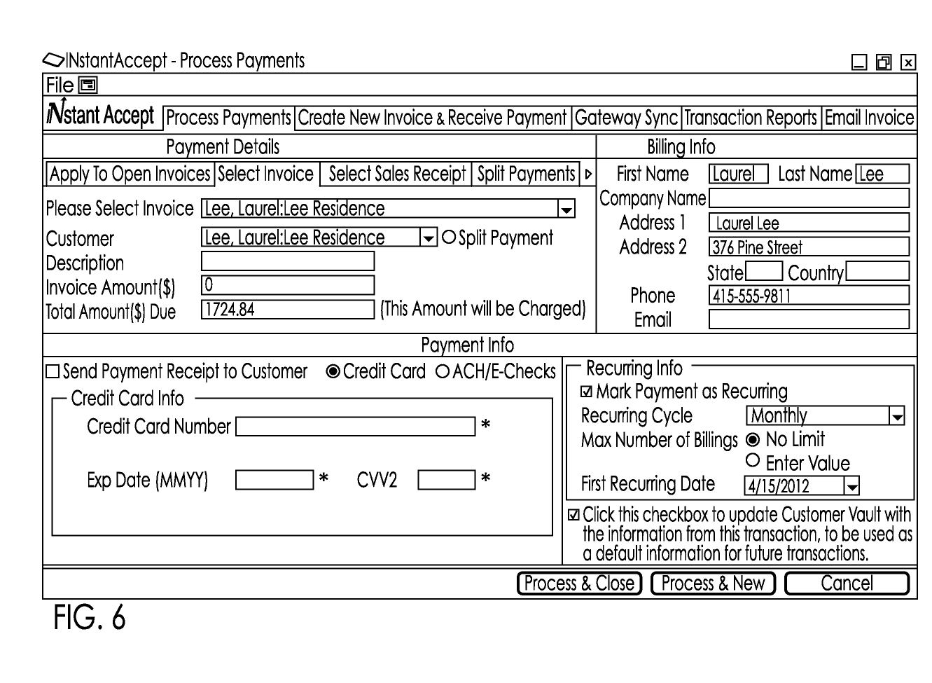

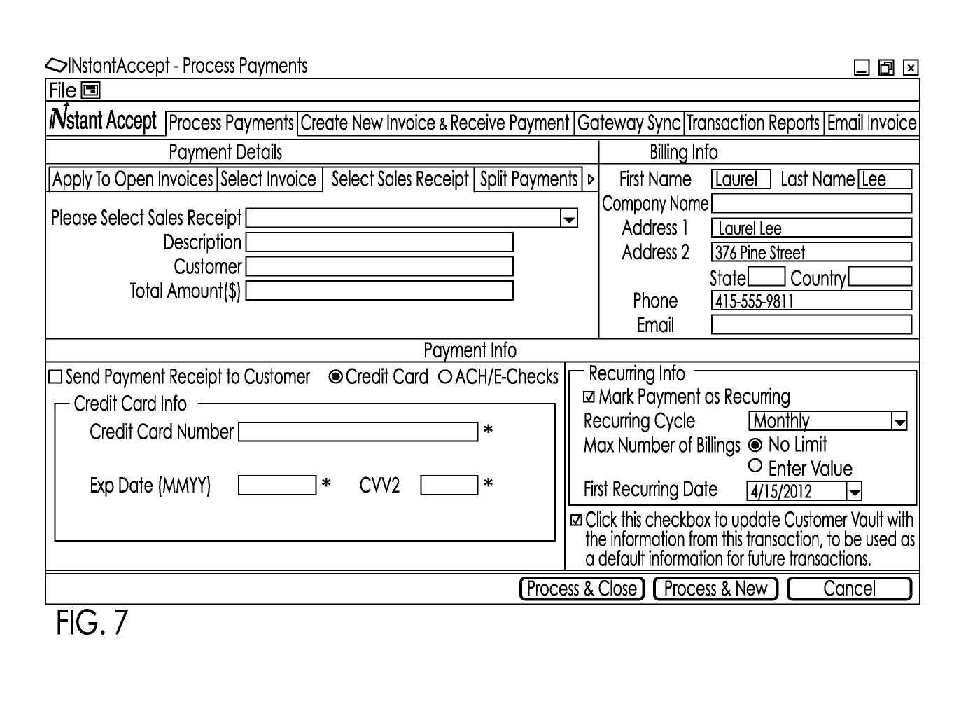

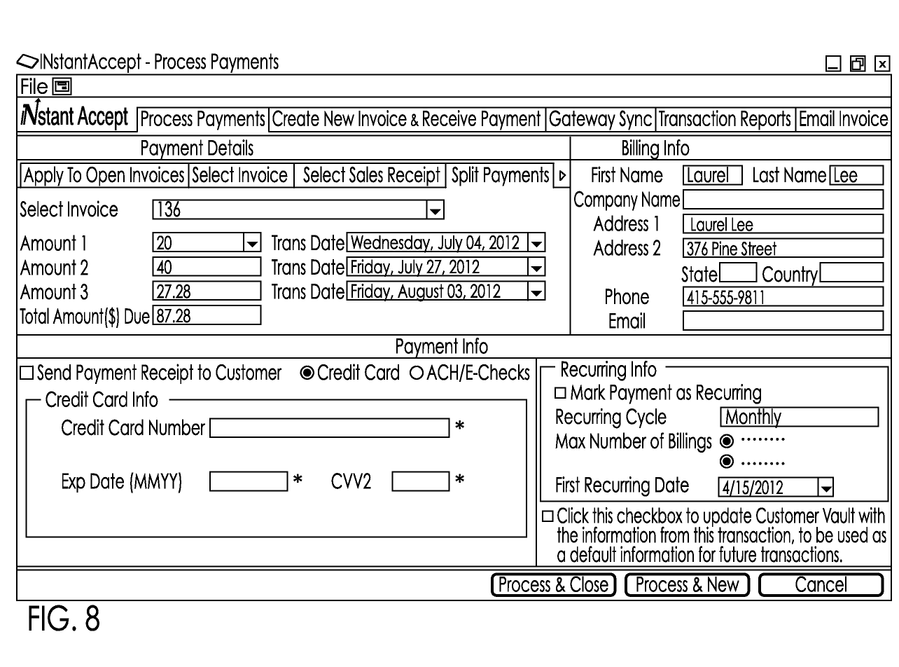

In the embodiments depicted in FIGS. 4-12, the second interface (203) is implemented as a web page (3035). In the depicted embodiments of FIGS. 4-8, the second interface provides, among other things, features and functionality pertaining to payment processing. In the embodiment depicted in FIG. 4, a set of forms allows the merchant to process all open invoices for a customer, create new customers and/or jobs, establish recurring payments, update customer information, and send receipts. In the depicted embodiment of FIG. 4, the merchant's instructions will be applied to all open invoices for the selected customer. In the embodiment depicted in FIG. 5, the same general set of forms is depicted with different options selected; in particular, recurring payment options are enabled in FIG. 5. In the embodiment depicted in FIG. 6, the same general interface options as those depicted in FIGS. 4-5 are displayed, but the operational context is that the merchant is selecting a specific invoice. In the embodiment depicted in FIG. 7, the same general interface options as those depicted in FIGS. 4-6 are displayed, but the operational context is that the merchant is selecting a specific sales receipt. In the embodiment depicted in FIG. 8, the same general interface options as those depicted in FIGS. 4-7 are displayed, but the operational context is that the merchant is splitting payment among a plurality of transaction dates and amounts. Again, it should be recalled that end-user interactions with this interface causes the accounting software (111) to record and process the requested transactions in real-time using the SDK/API, including by accepting payments through devices (307) not supported by the accounting software (111), and by using payment processors (315) and platforms not supported by the accounting software (111).

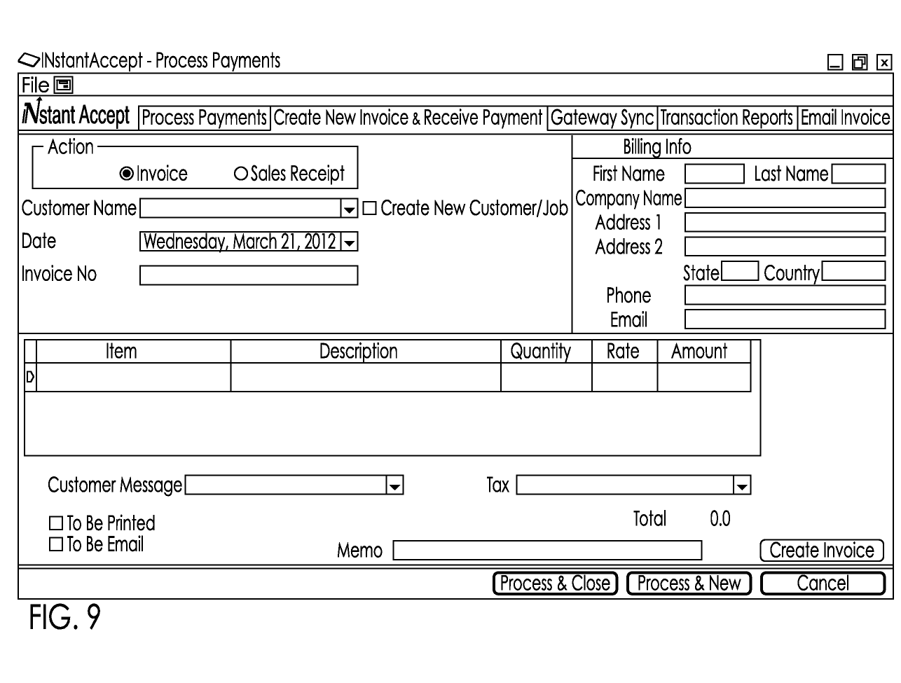

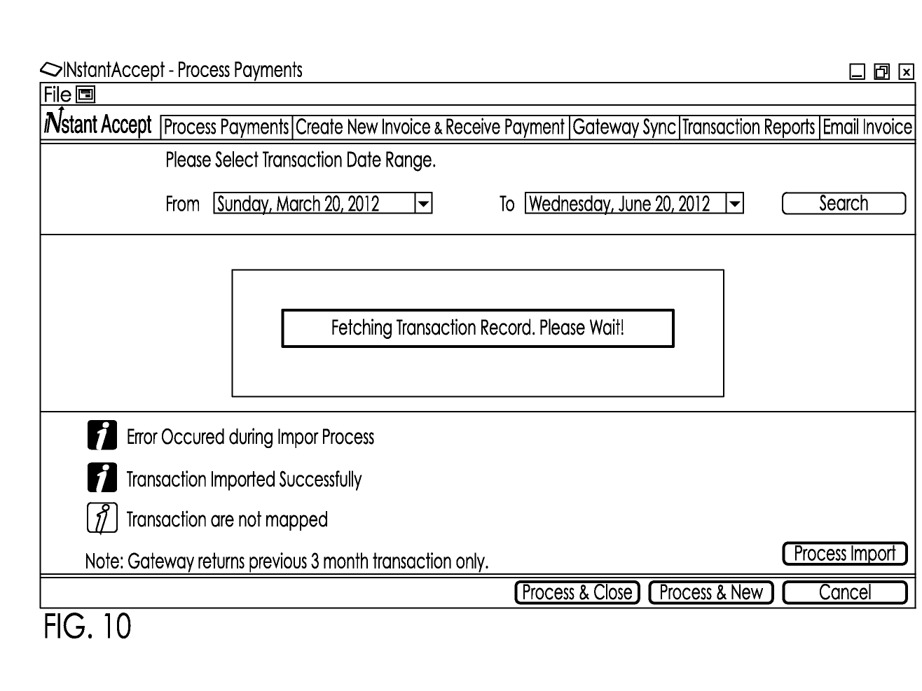

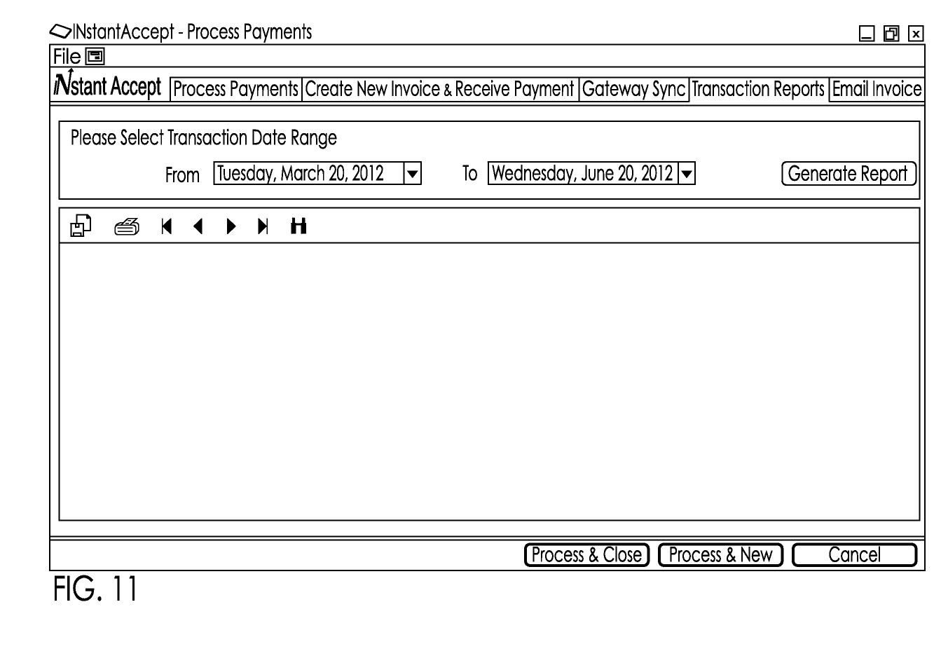

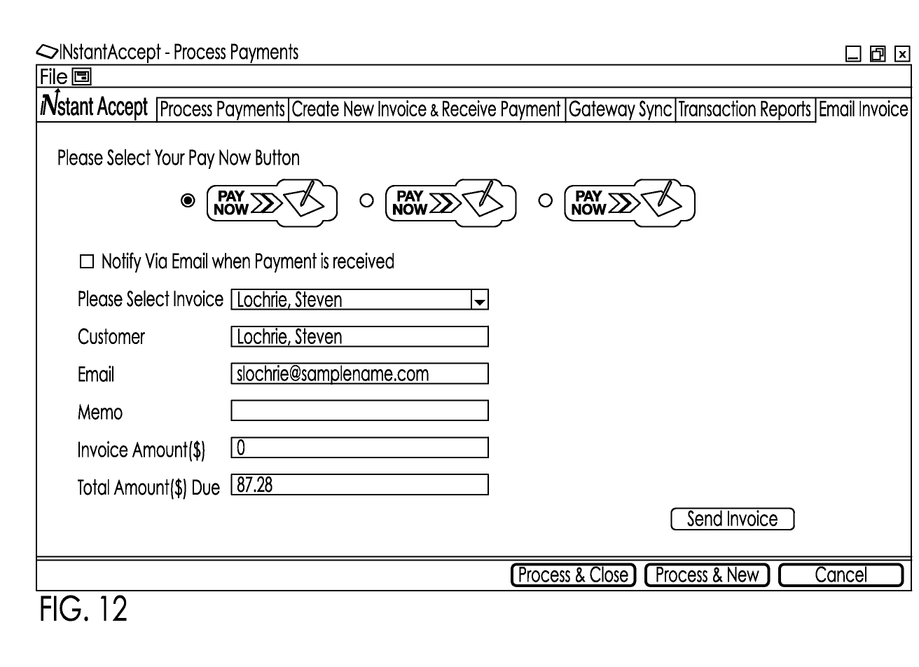

In the embodiment depicted in FIG. 9, the merchant may manually generate a new invoice. FIG. 11 depicts a form through which the merchant may generate reports on transactions processed by the payment processor, and FIG. 10 depicts a splash screen indicating to the merchant that the requested transaction report is being generated. FIG. 12 depicts an interface allowing the merchant to send e-mail invoices by selecting a customer and invoice amount.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A method for automatically recording an accounting transaction in real-time comprising:
providing an accounting software computer connected to a data network and including:
a memory having computer-readable instructions comprising accounting software;
an accounting database in a format usable by said accounting software;
providing a remote computer device communicating with said accounting software computer over said data network;
supplying said remote computer device with transaction data related to a point of sale transaction as part of said point of sale transaction;
in response to receiving said transaction data and without human direction said remote computer device sending to said accounting software computer over said data network a data structure including a recording instruction and at least some of said transaction data;
in response to said accounting software computer receiving said data structure and without human direction said accounting software recording in said accounting database an accounting transaction instructed by said recording instruction, said accounting transaction including at least some of said transaction data from said data structure; and
automatically recording an accounting transaction in real-time.

2. The method as claimed in claim 1, wherein said at least some of said transaction data in said data structure includes a payment amount and said recording instruction instructs said accounting software to create in said accounting database an invoice for said point of sale transaction, said invoice having an invoice amount equal to said payment amount.

3. The method as claimed in claim 2, wherein said recording instruction further instructs said accounting software to close said invoice.

4. The method as claimed in claim 1, wherein said data structure including at least some of said transaction data includes a payment amount and said recording instruction instructs said accounting software to close an existing open invoice for said point of sale transaction.

5. The method as claimed in claim 4, wherein said accounting software identifies said existing open invoice at least in part by matching said payment amount with the amount of said existing open invoice.

6. The method as claimed in claim 1, wherein said remote computer device is a mobile device.

7. The method as claimed in claim 6, wherein said mobile device is a mobile phone or tablet computer.

8. The method as claimed in claim 1, where the method further comprises:
in said providing a remote computer device, said remote computer device further comprising a display; and
in said supplying step, said supplying including a human inputting said transaction data into a user interface displayed on said display.

9. The method as claimed in claim 8, wherein said user interface is a web page.

10. The method as claimed in claim 1, wherein said data structure is a qbXML object.

11. A method for automatically recording in accounting software a transaction using an unsupported device comprising:
providing an accounting software computer connected to a data network and having:
an accounting database;
a memory having computer-readable instructions comprising accounting software supporting automatic recording in said accounting database of an accounting transaction corresponding to a payment made using a supported payment card reader;
providing a remote computer device communicating with said accounting software computer over said data network and having connected thereto an unsupported payment card reader communicating with said remote computer device, said unsupported payment card reader being unsupported by said accounting software;
accepting a payment for a point of sale transaction with said unsupported payment card reader;
said unsupported payment card reader supplying said remote computer device with transaction data related to said point of sale transaction as part of said point of sale transaction;
in response to receiving said transaction data and without human direction said remote computer device sending to said accounting software computer over said data network a data structure including a recording instruction and at least some of said transaction data;
in response to said accounting software computer receiving said data structure and without human direction said accounting software recording in said accounting database an accounting transaction instructed by said recording instruction, said accounting transaction including at least some of said transaction data from said data structure; and
automatically recording in said accounting software said point of sale transaction using said unsupported payment card reader.

12. The method of claim 11, wherein said method further comprises:
acquiring a cardholder identifier from a payment card read by said unsupported payment card reader;
in said supplying step, said unsupported payment card reader supplying said remote computer device with said cardholder identifier;
in said sending step, said data structure including said cardholder identifier; and
in said recording step, said accounting transaction including said cardholder identifier.

13. The method as claimed in claim 12, wherein said cardholder identifier is a primary account number.

14. The method as claimed in claim 12, wherein said cardholder identifier is a name.

15. The method as claimed in claim 12, wherein the method further comprises:
said remote computer device sending to a payment card processing vendor said cardholder identifier supplied to said remote computer device;
said remote computer device receiving from said payment card processing vendor a response including cardholder personal data related to said cardholder identifier;
in said sending step, said data structure including at least some of said cardholder personal data received by said remote computer device; and
in said recording step, said accounting transaction including at least some of said cardholder personal data from said data structure.

16. A method for recording in accounting software a transaction processed by an unsupported payment processing vendor comprising:
providing an accounting software computer connected to a data network and having:
an accounting database;
a non-transitory memory having computer-readable instructions comprising accounting software supporting automatic recording in said accounting database of an accounting transaction corresponding to a payment processed by a supported payment card processing vendor;
providing a remote computer device communicating with said accounting software computer over said data network and processing a payment made by a payment card using a payment card processing vendor unsupported by said accounting software;
accepting a payment for a point of sale transaction with a payment card;
reading from said payment card a cardholder identifier;
sending to said unsupported payment card processing vendor a payment processing request including said cardholder identifier;
receiving from said unsupported payment card processing vendor an indication of a disposition of said payment processing request;
said remote computer device sending to said accounting software computer over said data network a data structure including transaction data relating to said point of sale transaction and a recording instruction corresponding at least in part to said indication of a disposition; and
said accounting software computer receiving said data structure and said accounting software recording in said accounting database an accounting transaction instructed by said recording instruction, said accounting transaction including at least some of said transaction data from said data structure.

17. The method as claimed in claim 16, wherein said cardholder identifier is a primary account number.

18. The method as claimed in claim 16, wherein said cardholder identifier is a name.

19. The method as claimed in claim 16, wherein said method further comprises:
in said receiving step, further receiving from said unsupported payment card processing vendor cardholder personal data related to said cardholder identifier;
in said sending step, said data structure including at least some of said cardholder personal data; and
in said recording step, said accounting transaction including at least some of said cardholder personal data from said data structure.
